(19) United States
(12) Patent Application Publication
(10) Pub. No.: US 2006/0016092 A1
(43) Pub. Date: Jan. 26, 2006

(54) Washing machine or drying machine having drying duct with heater

(75) Inventors: Hyung-kyoon Kim, Gyeonggi-do (KR); Sang-yeon Pyo, Gyeonggi-do (KR); Byoung-yull Yang, Gyeonggi-do (KR); Hwang-mook Cho, Gyeonggi-do (KR); Jae-ryong Park, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/183,889

(22) Filed: Jul. 19, 2005

(30) Foreign Application Priority Data
Jul. 20, 2004 (KR) 2004-0056274

(51) Int. Cl. F26B 21/06; F26B 11/02

(52) U.S. Cl. 34/130; 34/607

(57) ABSTRACT

A drum washing machine includes a drum; a drying duct communicating with the drum; a fan for introducing air into the drying duct; and a heater provided in the drying duct and for heating the air from the fan. The drying duct is insulated so as to prevent heat generated by the heater from being radiated outward. Thus, the drum washing machine prevents heat generated by the heater from being radiated from the drying duct, thereby reducing heat-loss.

### CROSS-REFERENCE TO RELATED APPLICATIONS

This application claims the benefit of Korean Patent Application No. 2004-0056274, filed Jul. 20, 2004, in the Korean Intellectual Property Office, the disclosure of which is incorporated herein by reference.

### BACKGROUND OF THE INVENTION

1. Field of the Invention

An apparatus consistent with the present invention relates to a washing machine and, more particularly, to a washing machine supplying air at a high temperature, which is heated by a heater provided inside a drying duct, into a drum to dry clothes.

2. Description of the Related Art

Generally, a washing machine is an appliance intended to carry out a washing operation by falling clothes during rotation through 360 degrees of a rotatable washing chamber, and it also carries out rinsing, dewatering and drying operations.

A drying operation of the washing machine is classified into a circulation drying operation circulating inner air discharged from a drum, and a non-circulation drying operation supplying external air into the drum to dry the clothes.

A conventional washing machine comprises a drum accommodating clothes; a drying duct provided to be communicated with the drum; a fan introducing air into the drying duct; and a heater provided inside the drying duct and heating the air from the fan. With this configuration, the air which is heated by the heater to a high temperature is supplied into the drum to dry the clothes. The conventional washing machine with this configuration is disclosed in Korean Patent Application Nos. 10-2002-0001733 and 10-2002-0052977.

As shown in FIG. 1, the drying duct 2 comprises aluminum material with good heat-resistance to protect a surface thereof from the heater 4 generating heat at a high temperature.

However, the heat generated from the heater 4 is likely to radiate from the drying duct 2, thereby causing heat-loss. Accordingly, heating efficiency of the drum washing machine is relatively decreased and power consumption thereof is increased.

Also, due to the quality of the material of the drying duct 2, the surface temperature of the drying duct 2 is increased so that the drum washing machine may separately control the temperature thereof and the drying duct 2 may be designed to minimize heat-transformation by the heater 4 by using heat-resisting material.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

Accordingly, an aspect of the present invention provides a washing machine which prevents heat generated by a heater from being radiated from a drying duct, thereby reducing heat-loss.

Additional aspects and/or advantages of the invention will be set forth in part in the description which follows and, in part, will be apparent from the description, or may be learned by practice of the invention.

The foregoing and/or other aspects of the present invention are achieved by providing a washing machine comprising: a drum; a drying duct communicating with the drum; a fan which introduces air into the drying duct; and a heater provided in the drying duct and which heats the air from the fan, wherein the drying duct is insulated so as to prevent heat generated by the heater from being radiated outward.

According to an exemplary embodiment of the present invention, the drying duct comprises an outer duct; an inner duct provided inside the outer duct, and on which the heater is disposed; and a heat insulating part provided between the outer duct and the inner duct.

According to an exemplary embodiment of the present invention, the heat insulating part comprises an air layer provided between the outer duct and the inner duct.

According to another exemplary embodiment of the present invention, the heat insulating part comprises an insulator provided between the outer duct and the inner duct.

According to a further exemplary embodiment of the present invention, the inner duct comprises aluminum.

According to a still further exemplary embodiment of the present invention, the outer duct comprises plastics.

The present invention further provides a drying machine comprising a drum; a drying duct communicating with the drum; a fan which introduces air into the drying duct; and a heater provided in the drying duct and which heats the air from the fan, the drying duct being insulated so as to prevent heat generated by the heater from being radiated outward.

### BRIEF DESCRIPTION OF THE DRAWINGS

These and/or other aspects and advantages of the invention will become apparent and more readily appreciated from the following description of the exemplary embodiments, taken in conjunction with the accompanying drawings, in which:

FIG. 1 is a sectional view illustrating a configuration of a drying duct of a conventional drum washing machine;

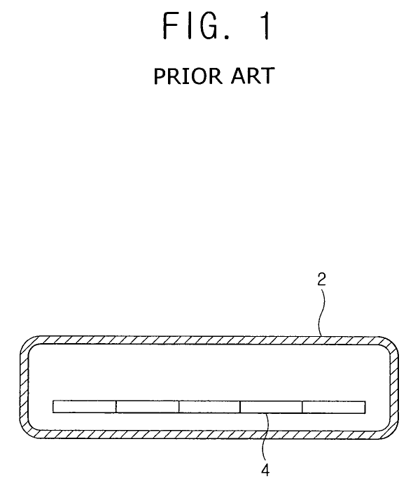

FIG. 2 is a perspective view of a washing machine according to the present invention;

FIG. 3 is a sectional view of a washing machine according to the present invention;

FIG. 4 is a sectional view illustrating a first embodiment of a drying duct provided in a washing machine according to the present invention; and

FIG. 5 is a sectional view illustrating a second embodiment of a drying duct provided in a washing machine according to the present invention.

### DETAILED DESCRIPTION OF THE ILLUSTRATIVE, NON-LIMITING EMBODIMENTS OF THE INVENTION

Reference will now be made in detail to the illustrative, non-limiting embodiments of the present invention, examples of which are illustrated in the accompanying drawings, wherein like reference numerals refer to the like elements throughout.

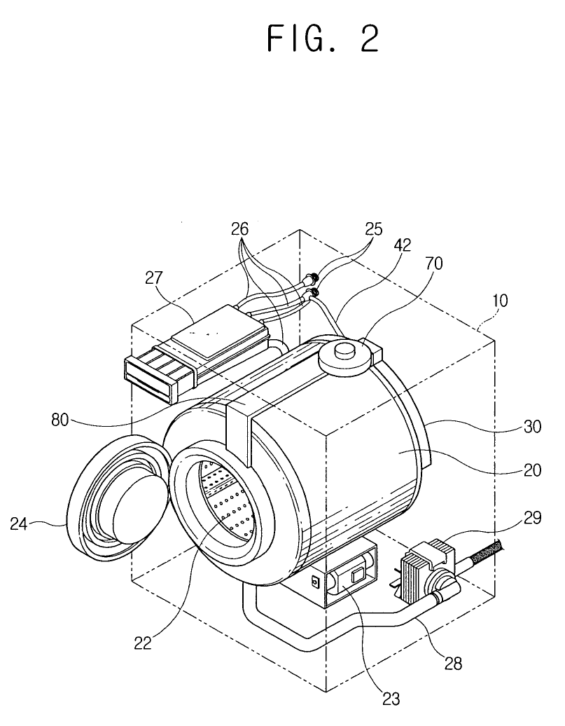

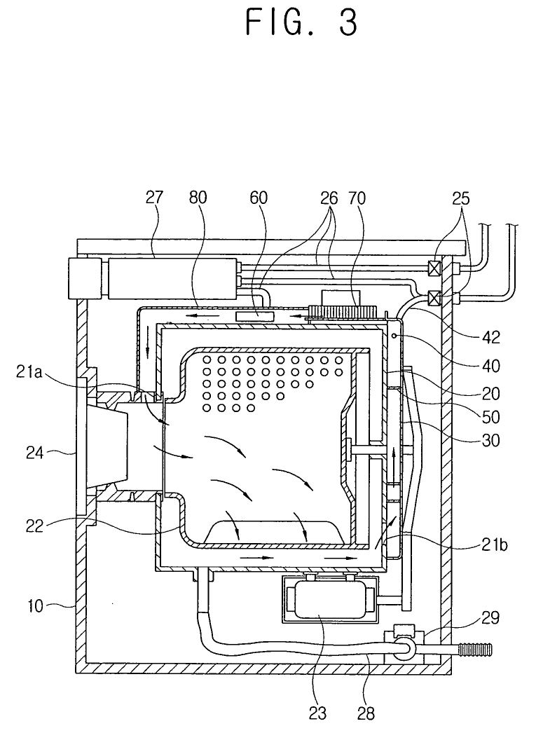

As shown in FIGS. 2 and 3, a washing machine consistent with the present invention comprises a main body 10 of a hexahedron shape; a cylindrical drum 20 provided in the main body 10, and for containing clothes therein; a cylindrical washing chamber 22 rotatably provided in the drum 20, and having a dewatering hole formed on a wall thereof; a driving motor 23 provided in a lower portion of the drum 20, and rotating the washing chamber 22 clockwise or counterclockwise to operate a washing, rinsing and dewatering process; and a door 24 provided to be opened/closed in a front portion of the main body 10.

In an upper portion of the drum 20 is respectively provided a water supply unit such as a water supply valve 25, a water supply pipe 26, a detergent dissolving unit 27 and the like to supply water and at the same time dissolve a laundry detergent, and a drying unit to dry the clothes after the dewatering process.

The drying unit comprises a fan 70 provided in an upper portion of the drum 20; a drying duct 80 provided to be communicated with the fan 70 and an air inlet 21 a of the drum 20; a heater 60 provided inside the drying duct 80; a condensing duct 30 communicating with an air outlet 21b of the drum 20 and the fan 70; a coolant spray 40 provided inside the condensing duct 30, and for spraying coolant; and a coolant supply pipe 42 connected to the coolant spray 40 and supplying the coolant to the coolant spray 40.

With this configuration, air supplied by the fan 70 passes through the drying duct 80 and is heated by the heater 60. The heated air is supplied into the drum 20 through the air inlet 21b to dry the clothes. The air of high temperature and high humidity, which is generated during the drying process, is introduced into the condensing duct 30 through the air outlet 21b of the drum 20, and then moisture in the air at high temperature and high humidity, which was introduced into the condensing duct 30, is discharged outward after the moisture is condensed by the coolant sprayed through the coolant spray 40 when the air of high temperature and high humidity is introduced into the drying duct 80 through the condensing duct 30.

Inside the condensing duct 30 is provided a condensing guide 50 to enhance condensation efficiency. The shape and an installation position of the condensing guide 50 may be variously changed as necessary.

In a lower portion of the drum 20 is provided a drain unit comprising such as, for example, a drain pipe 28, a drain pump 29 and the like to drain washing water inside the drum 20.

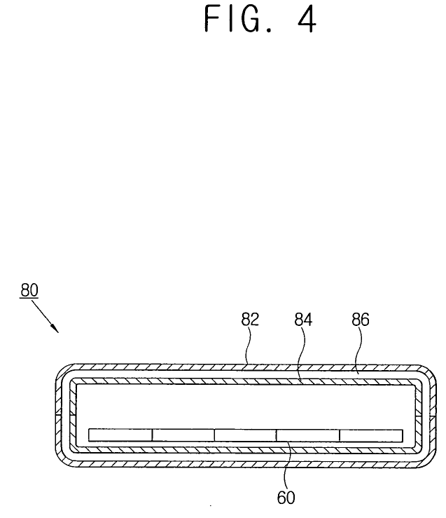

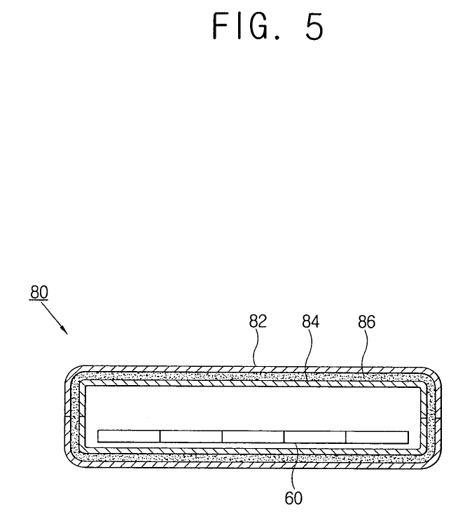

As shown in FIGS. 4 and 5, the drying duct 80 comprises an outer duct 82; an inner duct 84 provided inside the outer duct 82 and accommodating the heater 60; and a heat insulating part 86 provided between the outer duct 82 and the inner duct 84. The drying duct 80 is insulated to reduce heat-loss of the heat generated from the heater 60 and to minimize an increase of surface temperature by the heater 60.

The outer duct 82 and the inner duct 84 may be respectively divided into an upper part and a lower part so as to be easily assembled and accommodate the heater 60. However, the configuration thereof may comprise a single body and may be variously changed as necessary.

The heat insulating part 86 may prevent the heat-loss of the heat generated by the heater 60 and may minimize the increase of the surface temperature of the outer duct 82. The heat insulating part 86 is preferred, but not necessary, to entirely cover an inside of the outer duct 82. However, the heat insulating part 86 may partly cover the inside thereof.

The heat insulating part 86 may comprise an air layer in a space between the outer duct 82 and the inner duct 84 as shown in FIG. 4 or comprise an insulator between the outer duct 82 and the inner duct 84 as shown in FIG. 5. Specially, when the heat insulating part 86 comprises the air layer, the air layer is preferably, but not necessarily, trapped in an airtight space so as not to allow air to flow in or out of the airtight space.

The insulator may selectively comprise materials with good heat-insulation.

The inner duct 84 may comprise aluminum with heat resistance or stainless steel, etc. which may reflect the heat generated from the heater 60 to an inside thereof to enhance heating efficiency. The inner duct 84 may comprise various materials so far as the inner duct 84 is not transformed by the heat from the heater 60.

Because the heat insulating part 86 insulates the outer duct 82 from the heat, the surface temperature of the outer duct 82 is not increased so that the outer duct 82 may selectively comprise aluminum or plastics, etc.

The present invention is described with regard to the washing machine of circulating drying operation by way of an exemplary embodiment. However, all kinds of washing machines or drying machines comprising the drying duct having the heater, and of a non-circulating operation may be provided therein.

Moreover, while the present invention describes a circulation drying operation washing machine as an exemplary embodiment, it is possible that similar devices such as a non-circulation drying operation washing machine and a drying machine comprising a condensing duct to have a built-in heater are also usefully applied by those skilled in the art. In such a case, a drum of a washing machine performs the same function as a drum of a drying machine to accommodate clothing. Also, the other elements are identically applicable.

The configuration of the drying machine is similar to that of the washing machine shown in FIGS. 2 and 3. Thus, the drawing of the drying machine is not shown in this specification.

Although exemplary embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A washing machine comprising:
a drum;
a drying duct communicating with the drum;
a fan which introduces air into the drying duct; and
a heater provided in the drying duct and which heats the air from the fan,
the drying duct being insulated so as to prevent heat generated by the heater from being radiated outward.

2. The washing machine according to claim 1, wherein the drying duct comprises an outer duct; an inner duct provided inside the outer duct, and on which the heater is disposed; and a heat insulating part provided between the outer duct and the inner duct.

3. The washing machine according to claim 2, wherein the heat insulating part comprises an air layer provided between the outer duct and the inner duct.

4. The washing machine according to claim 2, wherein the heat insulating part comprises an insulator provided between the outer duct and the inner duct.

5. The washing machine according to claim 2, wherein the inner duct comprises aluminum.

6. The washing machine according to claim 3, wherein the inner duct comprises aluminum.

7. The washing machine according to claim 4, wherein the inner duct comprises aluminum.

8. The washing machine according to claim 5, wherein the outer duct comprises plastics.

9. The washing machine according to claim 6, wherein the outer duct comprises plastics.

10. The washing machine according to claim 7, wherein the outer duct comprises plastics.

11. The washing machine according to claim 2, wherein the inner duct comprises stainless steel.

12. The washing machine according to claim 2, wherein the outer duct comprises aluminum.

13. A drying machine comprising:
a drum;
a drying duct communicating with the drum;
a fan which introduces air into the drying duct; and
a heater provided in the drying duct and which heats the air from the fan,
the drying duct being insulated so as to prevent heat generated by the heater from being radiated outward.

14. The drying machine according to claim 13, wherein the drying duct comprises an outer duct; an inner duct provided inside the outer duct, and on which the heater is disposed; and a heat insulating part provided between the outer duct and the inner duct.
